(19) United States
(12) Patent Application Publication
(10) Pub. No.: US 2017/0114822 A1
(43) Pub. Date: Apr. 27, 2017

(54) COUNTER-BORED HEX NUT WITH CAPTIVATED WASHER

(71) Applicant: Joe A Garcia, Santa Fe Springs, CA (US)

(72) Inventor: Joe A Garcia, Santa Fe Springs, CA (US)

(21) Appl. No.: 14/922,437

(22) Filed: Oct. 26, 2015

(51) Int. Cl. F16B 39/24; F16B 43/00

(52) U.S. Cl. CPC F16B 39/24; F16B 43/00

(57) ABSTRACT

An improved counter-bored hex nut of the kind common to the aerospace industry for connecting panels to one another. The hex nut has a positive washer retention feature by which the washer is captivated to prevent the washer from bending away from and/or sliding off the nut. In particular, the improved hex nut has a hexagonal head at one end, to surround a threaded bore and a cylindrical base at the opposite end to surround a counter bore, A coextensive washer retaining lip extends radially from the cylindrical base of the nut so as to encircle the counter bore. A three is applied to the washer so that a cylindrical side wall thereof is bent over and completely around the washer retaining lip of the nut and bided flat against the cylindrical base of the nut below the counter bore.

### BACKGROUND OF THE INVENTION

1. Field of the Invention

This invention relates to a counter-bored hex nut of the kind used with a threaded fastener to secure panels together, such as those common to the aerospace industry. The hex nut has a positive washer retention feature by which a washer is reliably captivated so as to prevent the washer from bending away from and/or sliding off the nut.

2. Background Art

Referring initially to FIGS. 1-3 of the drawings, there is shown the combination of a conventional threaded bolt 1 and a conventional counter-bored hex nut 3 by means of which a pair of flat panels 5 and 7 are held together. The combination threaded bolt 1 and hex nut 3 shown in FIGS. 1-3 has particular application for connecting panels 5 and 7 one against the other as is common in the aerospace industry. By way of example, the panels 5 and 7 are part of the assembly of a wing or fuselage of an aircraft.

A pair of axially aligned holes 9 and 10 which are formed (e.g., drilled) in the flat panels 5 and 7 are sized to receive the threaded bolt 1 therethrough. The hex nut 3 includes a hexagonally shaped head 11 at the top thereof that surrounds a threaded bore 12. A base 13 at the bottom of the hex nut 3 surrounds a wider counter bore 14. With the threaded bolt 1 moved through the holes 9 and 10 of the panels 5 and 7, the threaded bore 12 at the head 11 of the hex nut 3 is rotated into tightened engagement with a threaded end 16 of the bolt 1. The aforementioned nut installation process is typically performed by means of an automated hex or double hex drive. A large number of bolt and hex nut combinations are required to fasten a pair of large panels 5 and 7 to one another.

To expand the seating surface of the hex nut 3 against the upper-most panel 5 and better maintain the connection of the hex nut 3 to the threaded end 16 of the bolt 1, it is known to attach a thin washer 20 around the base 13 of the hex nut 3 so as to surround the counter bore 14 through which the threaded bolt 1 is first installed. The base 13 of the conventional hex nut 3 has an outwardly flared portion with a uniform taper 22 (best shown in FIG. 3). In this case, the washer 20 is usually a flat piece of metal that is bent upwardly so that a side wall 24 thereof lies against the uniform taper 22 of the flared portion of the base 13 of the convention nut 3.

The common practice of simply coning the washer 20 over the taper 22 of the base 13 of the nut 3 may not be sufficient to reliably hold the washer 20 in place around the base when the combination is packaged and shipped. That is, with little to firmly anchor it in place, the washer 20 has been known to slide off the nut 3. In this same regard, during installation of the washer covered nut, the automated nut feeding and installation equipment, which has only limited ability to accommodate hex nuts with other than a predetermined outside diameter, can jam, whereby the manufacturing process will be interrupted.

What is even more, because of the extreme mechanical forces to which the hex nut 3 is subjected once the panels 5 and 7 have been assembled and placed into use on an aircraft, the upturned side wall 24 of the washer 20 has also been known to loosen and bend away from the taper 22 of the nut base 13 (best illustrated in FIG. 3). Such loosening and bending of the side wall 24 of the washer 20 can adversely affect the structural integrity of the interconnection of the panels 5 and 7. In the event that a large number of washers 20 are either missing or loosened, the assembly may have to be removed Rom the aircraft and reassembled. This could result in significant maintenance costs and down time to the aircraft upon which the combination threaded bolt 1 and counter-bore hex nut 3 is utilized.

Therefore, what would be desirable is an improved counter-bored hex nut that has a positive retention feature by which to reliably captivate a washer and prevent the washer from becoming loose and bending away from or sliding off the nut.

### SUMMARY OF THE INVENTION

In general terms, an improved counter-bored hex nut is disclosed to be rotated into mating engagement with a threaded bolt of the kind used to connect flat panels common to the aerospace industry. The hex nut has a positive washer retention feature by means of which a washer is reliably captivated so that the washer is unlikely to bend away from and/or slide off the nut which could adversely affect the structural integrity of the panel assembly. More particularly, the improved hex nut has a hexagonally-shaped head that surrounds a threaded bore through the top of the nut at which a rotational tightening force is applied and a cylindrical base that surrounds a counter bore through the bottom of the nut to be placed flush against the panel assembly at which to receive a threaded bolt. A coextensive washer retaining lip extends radially outward from the cylindrical base so as to encircle the counter bore at the bottom of the hex nut. That is to say, the outside diameter of the hex nut at the washer retaining lip is larger than the outside diameter of the nut at the cylindrical base from which the washer retaining lip extends. The washer is bent over and completely around the radially outward extending washer retaining lip so that the washer is captivated by the lip and held in place against the cylindrical base of the hex nut.

A press punch and a nut support bushing cooperate with one another to simultaneously retain the hex nut and bend the washer over and completely around the washer retaining lip to complete its captivation. Prior to its captivation by the nut, the washer includes a collar that surrounds a nut receiving opening. A uniformly cylindrical side wall of the pre-captivated washer stands upwardly from the collar. The improved hex nut having the aforementioned retention feature is moved into the nut receiving opening of the pre-captivated washer so that the collar of the washer lays against and surrounds the cylindrical base of the nut. Next, the hex nut is placed within and held by a hexagonally-shaped nut retaining channel that runs longitudinally through the nut support bushing. The press punch is then advanced towards the nut support bushing until a pilot pin of the press punch is moved through the counter bore and into the threaded bore of the hex nut. At the same time, an annular bending guide of the press punch which surrounds the pilot pin slides along the outside of the upstanding cylindrical side wall of the pre-captivated washer. A flat bending force generating edge that extends between the annular bending guide and the pilot pin of the advancing press punch is moved into contact with the upstanding cylindrical side wall of the pre captivated washer. Accordingly, a bending force is applied to cause the cylindrical side wall to bend over and completely around the washer retaining lip of the hex nut, whereby the washer is captivated by and held in place on the nut. The press punch is now moved away from the nut support bushing, following which the improved hex nut and the washer captivated thereby are removed from the nut support bushing so as to be ready for connection to a threaded bolt.

### BRIEF DESCRIPTION OF DRAWINGS

FIG. 1 is a perspective view of a conventional counter-bored hex nut having a washer extending around a tapered base thereof;

FIG. 2 shows the conventional hex nut and washer of FIG. 1 to be rotated into mating engagement with a threaded bolt by which to connect a pair of flat panels to one another;

FIG. 3 shows the conventional hex nut and washer of FIG. 1 mated to the threaded bolt for connecting the panels of FIG. 2 to one another with the washer bending away from the tapered base of the hex nut;

FIG. 4 is a perspective view of an improved counter-bored hex nut according to a preferred embodiment of this invention having a positive washer retention feature by which a washer is bent completely around and captivated by a washer retaining lip of the nut;

FIG. 5 shows the improved hex nut and captivated washer of FIG. 4 to be rotated into mating engagement with a threaded bolt by which to connect a pair of flat panels to one another;

FIG. 6 is an exploded view showing the improved hex nut with positive washer retention feature and the washer prior to the washer being bent completely around and captivated by the washer retaining lip of the nut;

FIG. 7 is an exploded view showing the improved hex nut and the pre-captivated washer of FIG. 6 with a press punch and a nut support bushing that cooperate with one another to bend the pre-captivated washer over and completely around the washer retaining lip of the nut; and

FIGS. 8-10 show the steps by which the press punch and the nut support bushing of FIG. 7 cooperate with one another so that the pre-captivated washer is bent over and completely around the washer retaining lip of the hex nut, whereby the washer is reliably captivated by the nut.

### DESCRIPTION OF THE PREFERRED EMBODIMENT

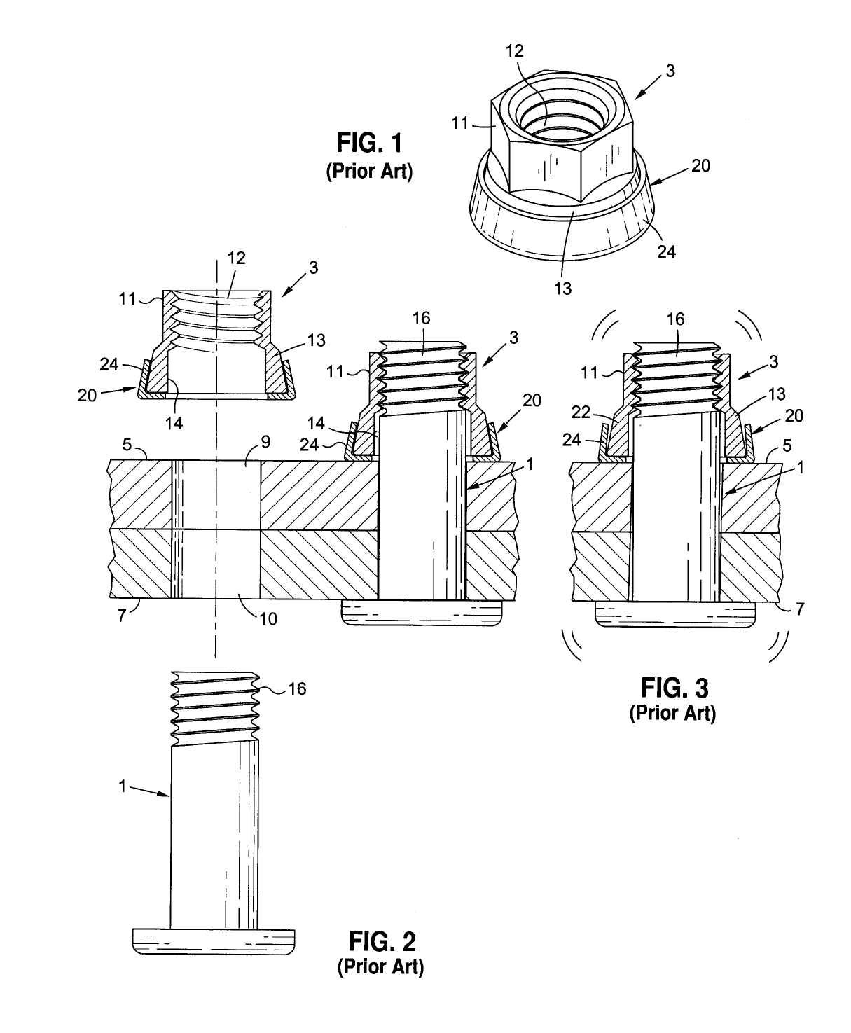

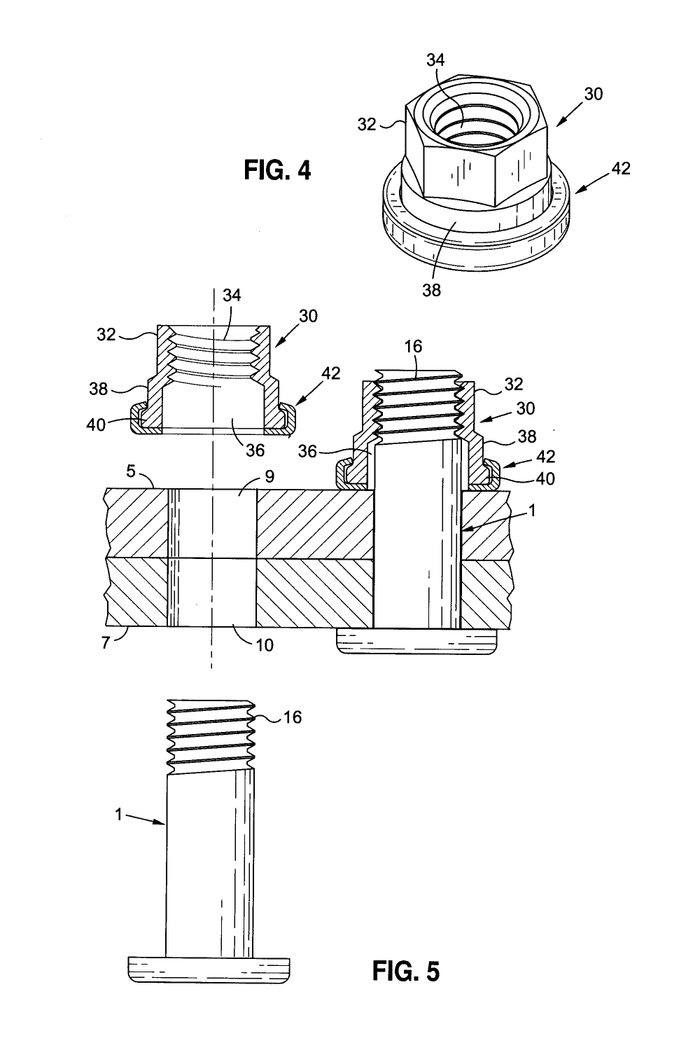

Turning now to FIGS. 4 and 5 of the drawings, there is shown an improved counter-bored hex nut 30 leaving a positive washer retention feature by which to reliably captivate a washer and thereby prevent the washer from loosening, bending away from and/or sliding off the nut so as to avoid the shortcomings associated with the washer that is attached to the conventional hex nut as was described while referring to FIGS. 1-3. Like the hex nut 3 shown in FIGS. 1-3, the improved hex nut 30 of FIGS. 4 and 5 is adapted to be rotated into mating engagement with the threaded end 16 of a conventional threaded bolt which is located through axially aligned holes 9 and 10 formed in a pair of flat panels 5 and 7. As was previously indicated, the panels 5 and 7 are common to those used in the aerospace industry. However, it should be understood that the improved hex nut 30 herein disclosed is not limited to use in the aerospace industry or to connecting flat panels together.

The improved hex nut 30 has a relatively narrow threaded bore 34 that is surrounded by a hexagonally-shaped head 32 at the top of the nut at which a rotational force is applied and a wider counter bore 36 that is surrounded by a cylindrical base 38 at the bottom of the nut. To be able to more reliably connect the improved hex nut 30 to the threaded end 16 of the bolt 1 after the bolt has been located through the axially aligned holes 9 and 10 in the panels 5 and 7, the cylindrical base 38 of the hex nut 30 is provided with as positive washer retention feature. More particularly, a coextensive washer retaining lip 40 extends radially outward from the cylindrical base 38 so as to encircle the counter bore 36 at the bottom of the hex nut 30 at which the threaded bolt 1 is initially received. The washer retaining lip 40 is wider than the cylindrical base 38 such that the outside diameter of the hex nut 30 at the radially outwardly extending washer retaining lip 40 is larger than the outside diameter of the nut at the cylindrical base 38.

Rather than laying against a tapered surface (designated 22 in FIG. 3) and possibly bending away from and sliding off the nut 3, a washer 42 is captured and held in place around the improved counter-bored hex nut 30 of FIGS. 4 and 5 by means of the aforementioned positive washer retention feature that is established by the washer retaining lip 40 which extends radially outward from the cylindrical base 38 of hex nut 30. That is, the thin metal washer 42 is now seated against the cylindrical base 40 while bending over and completely around the washer retaining lip 40. Moreover, the washer 42 is folded flat against the bottom of the improved hex nut 30 below the counter bore 36 so as to lie flush against the panel assembly once the hex nut has been connected to the threaded bolt 1.

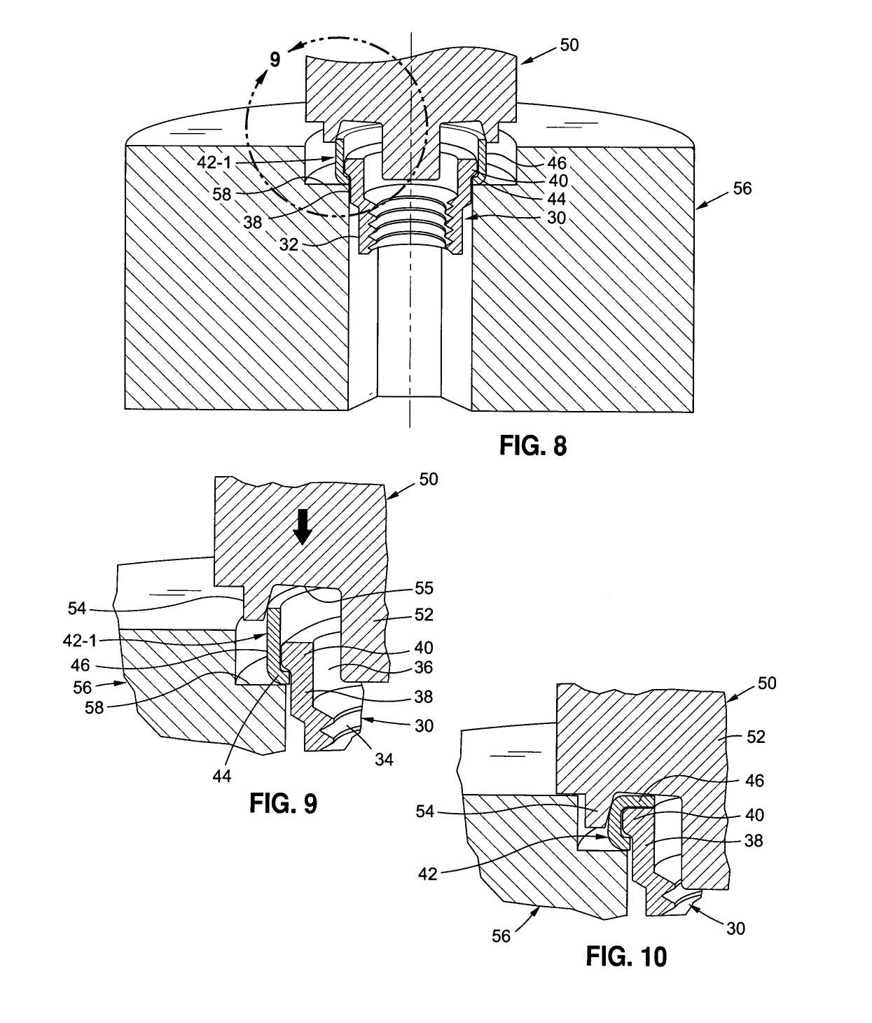

By virtue of the washer 42 being bent over and completely around the washer retaining lip 40 and being folded against the bottom of the hex nut 30 (in the manner shown in FIGS. 8-10, the washer is unlikely to bend away from or slide off the nut. Accordingly, the automatic nut feeding and installation process is less likely to be interrupted, and the integrity of the panels 5 and 7 being connected to one another is unlikely to be negatively impacted by the possibility of bent or missing washers.

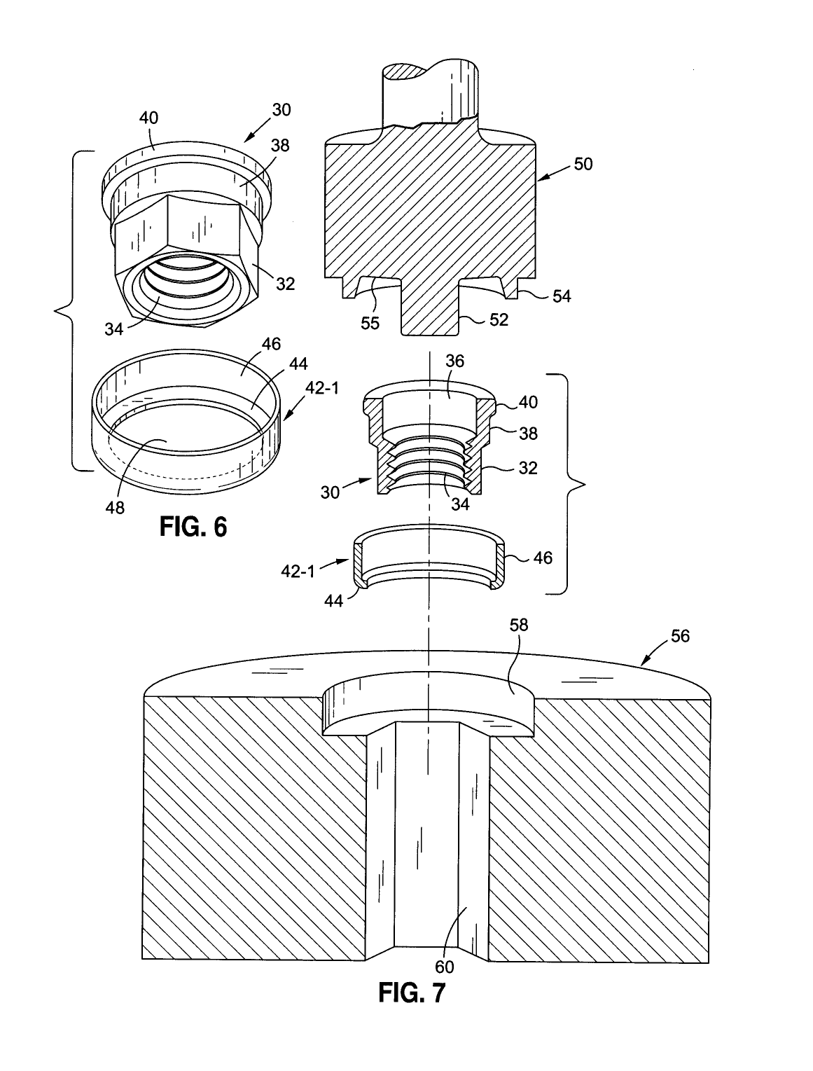

Referring to FIGS. 6-10 of the drawings, a press punch 50 and a nut support bushing 56 are shown cooperating with one another so that the washer 42 is bent over and completely around the radially outwardly extending washer retaining lip 40 and then folded against the bottom of the improved counter-bored hex nut 30 below the counter bore 36 thereof by which the washer is reliably captivated by the nut. Prior to it being bent around the washer retaining lip 40 and captivated by the improved hex nut 30, the pre-captivated washer (designated 42-1 in FIGS. 6-9 has a circular collar 44 and a uniformly cylindrical side wall 46 standing upwardly from the collar. The collar 44 surrounds a nut receiving opening 48 of the pre-captivated washer 42-1 that is sized to receive therethrough the hexagonally-shaped head 32 and the cylindrical base 38 of the hex nut 30 (best shown in FIG. 8).

The press punch 50 includes a downwardly projecting pilot pin 52, a downwardly projecting annular bending guide 54 which surrounds the pilot pin 52, and a flat, gently upsloping bending force generating edge 55 extending therebetween. The nut support bushing 56 has a press punch receiving cavity 58 formed in the top thereof and a hexagonally-shaped nut retaining channel 60 extending downwardly through bushing 56 from the press punch receiving cavity 58. Both the press punch 50 and the nut support bushing 56 are preferably manufactured from hardened steel.

FIG. 8 shows the pre-captivated washer 42-1 laying against the washer retaining lip 40 at the bottom of the hex nut 30 with the cylindrical side wall 46 of the washer standing upwardly from the collar 44 wards the press punch 50. The hex nut 30 is located on the support bushing 56 such that the washer retaining lip 40 is seated within the press punch receiving cavity 58, and the relatively wide cylindrical base 38 and the narrow head 32 depending therefrom are located inwardly of the nut retaining channel 60 of bushing 56.

FIG. 9 shows enlarged details from FIG. 8 with the press punch 50 located above and being advanced axially downwardly towards the nut support bushing 56 and the pre-captivated washer 42-1 that lays against the washer retaining lip 40 of the hex nut 30 located within the press punch receiving cavity 58 of bushing 56. The press punch 50 continues to advance towards the nut support bushing 56 until the pilot pin 52 oppress punch 50 is moved through the counter bore 36 and into the threaded bore 34 of the hex nut 30. At the same time, the annular bending guide 54 of press punch 50 that surrounds the pilot pin 52 slides along the outside of the upstanding cylindrical side wall 46 of the pre-captivated washer 42-1.

In FIG. 10, the flat bending force generating edge 55 that extends between the pilot pin 52 and the bending, guide 54 of press punch 50 is moved into contact with the upstanding cylindrical side wall 46 of the pre-captivated washer 42-1. Accordingly, the force generating edge 55 of the press punch 50 applies a bending force to cause the cylindrical side wall 46 to be bent over and completely around the washer retaining lip 40 of the improved hex nut 30. With the bending guide 54 of the press punch 50 sliding along and pushing the side wall 46 of the pre-captivated washer 46-1 against lip 40, the bending force generated by the three generating edge 55 of the press punch 50 causes the side wall 46 to be folded and lie flat against the bottom of the hex nut 30 below the counter bore 36 and the base 38 that is encircled by the washer retaining lip 40.

The press punch 50 is now moved away from the nut support bushing 56 at which time the improved hex nut 30 and the washer 47 coupled thereto are removed from the bushing. In this case, the washer 42 is now reliably captivated by its engagement to the hex nut 30 over and completely around the washer retaining lip 40 thereof.

1. A combination comprising:
a nut having a head at one end thereof to which to rotational force is to be applied, a threaded bore surrounded by said head, a base at the opposite end of said nut, a counter bore surrounded by said base to receive a threaded fastener to be mated to said nut at said threaded bore, said counter bore being wider than said threaded bore, and a washer retaining projection extending from the base of said nut; and
a washer surrounding the base of said nut and being bent over and around said washer retaining projection by a which said washer is captivated by and held in place against said nut.

2. The combination recited in claim 1, wherein the washer retaining projection extending from the base of said nut is a lip that surrounds said base.

3. The combination recited in claim 2, wherein the base of said nut is cylindrical and wherein said washer retaining lip extends radially outward from and encircles said cylindrical base, such that the outside diameter of said nut is wider at said washer retaining lip than at said cylindrical base.

4. The combination recited in claim 3, wherein said washer has a first end, an opposite end, and an intermediate portion between said first and opposite ends, the first end of said washer being seated on the cylindrical hose of said nut, the intermediate portion of said washer being bent over and around the washer retaining lip of said nut, and the opposite end of said washer being folded flat against the base of said nut so as to lie below the counter bore surrounded by said base.

5. The combination recited in claim 1, wherein said nut is a hex nut such that the head of said hex nut to which a rotation force is to be applied is hexagonal.

6. A combination comprising:
a nut having a head at one end thereof, a cylindrical base at the opposite end, a bore running completely through said nut between said head and said cylindrical base, and a coextensive washer retaining lip extending radially from and encircling said cylindrical base, such that said nut has a wider outside diameter at said washer retaining lip than at said cylindrical base; and
a washer surrounding the cylindrical base of said nut so as to be bent over and around said washer retaining lip and lay flat against said cylindrical base below said bore therethrough by which said washer is captivated by said nut.

7. A method for attaching a washer in surrounding engagement to a nut, wherein said nut has a head at one end thereof, a cylindrical base at the opposite end, a bore running completely through said nut between said head and said cylindrical base, and a washer retaining lip extending radially from and encircling said cylindrical base, such that said nut has a wider outside diameter at said washer retaining lip than at said cylindrical base, said method comprising the steps of:
bending said washer over and around the washer retaining lip extending radially from and encircling the cylindrical base of said nut; and
folding said washer so as to lie flat against said cylindrical base below the bore which runs through said nut.

8. The method recited in claim 7, wherein said washer has a circular collar and a cylindrical side wall extending from said circular collar, said method comprising the additional steps of:
positioning the circular collar of said washer in surrounding engagement with the cylindrical base of said nut;
bending the cylindrical side wall of said washer over and around the washer retaining lip of said nut; and
folding the cylindrical side all of said washer so as to lie flat against the cylindrical base of said nut below the bore which runs through said nut.

9. The method recited in claim 8, comprising the additional steps of holding said nut in a nut support; and moving a press punch towards said nut support for applying a force against the cylindrical side wall of said washer for bending said side wall over and around the washer retaining lip of said nut and for folding said cylindrical side wall against the cylindrical base of said nut so as to lie below the bore which runs through said nut.

10. The method recited in claim 9, wherein said press punch has a pilot pin projecting therefrom, an annular bending guide surrounding said pilot pin, and a force generating edge located between said pilot pin and said annular bending guide, said method comprising the additional step of moving said press punch towards said nut support until said pilot pin is received inwardly of the bore running through said nut, said annular bending guide slides over and applies a pushing force to the cylindrical side wall of said washer, and said force generating edge engages and applies said force to the cylindrical side wall of said washer for causing said side wall to bend over and around the washer retaining lip of said nut and to fold against the cylindrical base of said nut below the bore which runs through said nut.
